(19) United States
(12) Patent Application Publication
(10) Pub. No.: US 2022/0227014 A1
(43) Pub. Date: Jul. 21, 2022

(54) RAZOR WITH INTERMITTENT ENCAPSULATION OF EMBEDDED BLADES

(71) Applicant: RK INVENTIONS, LLC, Glencoe, IL (US)

(72) Inventors: Ryan Kole, Glencoe, IL (US); Matthew Spenko, Chicago, IL (US); Vincent Bowman, Highland Park, IL (US)

(21) Appl. No.: 17/580,762

(22) Filed: Jan. 21, 2022

Related U.S. Application Data
(60) Provisional application No. 63/140,040, filed on Jan. 21, 2021.

(51) Int. Cl. B26B 21/40; B26B 21/42

(52) U.S. Cl. CPC B26B 21/4012; B26B 21/4068; B26B 21/42

(57) ABSTRACT

A razor assembly includes a cartridge assembly with a plurality of raised ridges that slide against the surface of a user's skin and offset a distance relative to the surface of the user's skin at which one or more blades cut hair.

### CROSS-REFERENCE TO RELATED APPLICATION

This patent application claims the benefit of U.S. Provisional Patent Application No. 63/140,040, filed Jan. 21, 2021, which is incorporated by reference herein in its entirety.

### BACKGROUND

Males are shaving less than in the past due to facial hair becoming accepted in the workplace and female's preference for men with some facial hair. This decrease in shaves per week has negatively affected razor manufacturers' sales. The classic “razor/razor blade” model only works when a company can sell numerous razor blades.

Although beards are popular, there is also a trend of having and maintaining a minimal amount of facial hair, perhaps at the stage in between a full beard and no facial hair. This stage of hair growth or look is commonly referred to as “stubble”, “scruff”, or a “5 o'clock shadow.” This amount of hair usually measures from 0.4 mm to 1.5 mm in length but could be as great as 4 mm. To maintain this desired length of hair, a person is generally left with one of two options: (1) cyclically grow the hair out until it reaches beyond the desired length of hair and then shave or (2) use an electric or battery operated razor to keep the facial hair at the desired length. Option 1 does not provide for a consistent length of hair at any particular stage as it starts growing on day 1 and continues to grow until day 7 (for example) when it then needs to be shaved, bringing the facial hair down to 0 mm, also known as a clean shave. Option 2 is more expensive than a traditional manual shaving razor, can be bulky, requires a power source, is not ideal for travel, and can cause razor rashes.

A typical issue with manual razors is pinching or tugging of the hair, which is not comfortable to the shaver. This problem is exacerbated when creating a manual razor that purposely leaves a certain amount of hair remaining after a shave. The engineering of such a razor that provides for an “unclean” shave or stubble, scruff, or a 5 o'clock shadow, needs special attention to prevent the pinching or tugging of the hair plus maintaining an even shave throughout the face to prevent patches of hair that are longer or shorter than other patches on the face. Furthermore, for manual razors having a raised guard, hair shafts can get caught between the raised guard that sets the trimming length and the trimming blade. Thus, what is needed is a razor that increases user comfort and desirability.

### SUMMARY

A razor assembly comprising a cartridge assembly for housing one or more blades is disclosed. The cartridge assembly comprises a plurality of raised ridges configured to slide against the surface of a user's skin and offset a distance relative to the surface of the user's skin at which the one or more blades cut hair. The one or more blades are incorporated into the cartridge assembly without gaps between each of the one or more blades and the cartridge assembly.

In an aspect, the cartridge assembly is a single unit having the one or more blades embedded within.

In an aspect, the cartridge assembly comprises a cartridge top component and a cartridge bottom component and the one or more blades are sandwiched between the cartridge top component and the cartridge bottom component.

In an aspect, at least one of the cartridge top component and the cartridge bottom component comprise a single injection mold with the one or more blades embedded within.

In an aspect, the cartridge assembly further comprises a blade carriage configured to house the one or more blades and secure the one or more blades within the cartridge assembly, the blade carriage being sandwiched between the cartridge top component and the cartridge bottom component.

In an aspect, the cartridge assembly comprises a curved outer edge configured to contact a user's skin, and the one or more blades comprise cutting edges that are parallel to a plane tangent to the curved outer edge.

In an aspect, the one or more blades are angled relative to an axis of the cartridge assembly extending along a length of the cartridge assembly.

In an aspect, the one or more blades extend along different portions along the largest dimension of the cartridge assembly.

In an aspect, the razor assembly comprise at least two blades, and the at least two blades are configured at different angles relative to an outer surface of the cartridge assembly.

In an aspect, the razor assembly further comprises a handle having a mounting fork.

In an aspect, the mounting fork comprises pivot protrusions and the cartridge assembly comprises pivot recesses, the pivot protrusions configured to mate with the pivot recesses in an assembled state.

In an aspect, the mounting fork is configured to be compressible such that at least one of the pivot protrusions is released from a pivot recess.

In an aspect, the mounting fork comprises grip lines protruding outward from the mounting fork.

In an aspect, the distance relative to the surface of the user's skin at which the one or more blades cut hair is 0.4 to 4 millimeters.

In an aspect, the mounting fork comprises a recess configured to accommodate pivotal rotation of the cartridge assembly into the mounting fork.

In an aspect, the cartridge assembly further comprises one or more pegs, each of the one or more pegs configured to extend through the one or more blades and secure the one or more blades in the cartridge assembly when the one or more pegs are deformed.

A method of making a razor cartridge assembly is also disclosed, the method comprising providing a mold cavity, securing one or more razor blades within the mold cavity, and injection molding the cartridge assembly about the one or more razor blades.

In an aspect, the method further comprises angling the one or more razor blades such that at least two of the razor blades are not parallel.

In an aspect, the method further comprises angling the one or more razor blades such that the one or more razor blades are not parallel to an axis extending across the length of the mold.

In an aspect, the method further comprises sharpening a cutting edge of the one or more blades such that each cutting edge is parallel to a plane tangent to an outer surface of the cartridge assembly.

### BRIEF DESCRIPTION OF THE DRAWINGS

FIG. 1A depicts a top view, side view, and front view of an embodiment of a razor according to the present disclosure.

FIG. 1B depicts a close-up view of a cartridge and razor guard surface of an embodiment of a razor according to the present disclosure.

FIG. 2A depicts a close-up three-quarter view of a cartridge in an embodiment of a razor according to the present disclosure.

FIG. 2B depicts a three-quarter view of a blade cartridge and handle assembly in an embodiment of a razor according to the present disclosure.

FIG. 3A depicts a close-up view of a cartridge of an embodiment of a razor according to the present disclosure.

FIG. 3B depicts an exploded view of an embodiment of a razor according to the present disclosure.

FIG. 4A depicts close-up rear view of an embodiment of a razor according to the present disclosure.

FIG. 4B depicts a rear view of an embodiment of a razor according to the present disclosure.

FIG. 5A depicts a close-up cross-sectional view of a cartridge of an embodiment of a razor according to the present disclosure.

FIG. 5B depicts a close-up cross-sectional view of a detachable razor cartridge of an embodiment of a razor according to the present disclosure.

FIG. 5C depicts a bottom view of an embodiment of a razor assembly according to the present disclosure.

FIG. 6A depicts a close-up cross-sectional view of a detachable razor cartridge of an embodiment of a razor according to the present disclosure.

FIG. 6B depicts a plan view of an embodiment of a razor assembly according to the present disclosure.

FIG. 7A depicts a close-up cross sectional view of razor blades in a cartridge of an embodiment of a razor according to the present disclosure.

FIG. 7B depicts a plan view of an embodiment of a razor assembly according to the present disclosure.

FIG. 8A depicts a close-up cross-sectional view of razor blades in a cartridge of an embodiment of a razor according to the present disclosure.

FIG. 8B depicts a plan view of an embodiment of a razor assembly according to the present disclosure.

FIG. 9A depicts a close-up cross sectional view of razor blades in a cartridge of an embodiment of a razor according to the present disclosure.

FIG. 9B depicts a plan view of an embodiment of a razor assembly according to the present disclosure.

FIG. 10A depicts an embodiment of a razor having a wide handle and detachable blade according to the present disclosure.

FIG. 10B depicts a gripping or handling configuration of the wide handle depicted in FIG. 10A.

FIG. 11A depicts razor blades disposed at an angle across an embodiment of a razor according to the present disclosure.

FIG. 11B depicts an underside of a detachable cartridge of an embodiment of a razor according to the present disclosure.

FIG. 12A depicts a front view of a detachable cartridge of an embodiment of a razor according to the present disclosure.

FIG. 12B depicts side views of different embodiments of a razor according to the present disclosure having varying blade angle configurations.

FIG. 13 depicts a side view of a detachable cartridge with differently-oriented razor blades in an embodiment of a razor according to the present disclosure.

### DETAILED DESCRIPTION

In one embodiment, a razor that resolves some of the problems associated with typical razors in the art incorporates one or more razor blades into the razor's guard, thereby eliminating the gap or space between the razor blades and the guard. An advantage of this embodiment is that it is accommodating of a variety of razor designs, and can even be integrated into designs of currently available razors which otherwise do not incorporate blades in a guard.

In some embodiments, the razor blade is intermittently encapsulated by the razor guard or cartridge. In some embodiments, the blade may be embedded into the razor guard or cartridge by sandwiching the blade between the top half of the cartridge, which contacts the skin surface, and the lower half of the cartridge, which connects to the razor handle. The cartridge may also be manufactured in one piece where the cutting blades are suspended in an injection mold and injected with molded plastic around the blades, thus infusing the one-piece cartridge with the metal cutting blades suspended in the one-piece cartridge. In some embodiments, the cartridge may be built as one or more pieces, allowing for the razor blade to be suspended in the cartridge and preventing any gap or space between the parts. An advantage of each embodiment may be that each prevents a gap between the razor blade and razor guard that may lead to an uncomfortable shave. To alleviate any tugging or pinching of the hair shafts, the blade guard may include raised ridges, thereby controlling the distance between the blade or blades and the facial skin of a user.

A further benefit is the ease to remove shaved hair from the razor. Typically, manual razors require the blade to be rinsed in running water or shaken while immersed in water. The space under (or above) each razor blade in the embodiments of the present disclosure allow for trimmed hair to be easily and quickly removed, providing for a faster and more efficient shaving experience for a user.

In some embodiments, a lubricating strip is included on the razor blade cartridge trailing edge. Additionally, in another embodiment, a rubber strip may be integrated into the leading edge, thereby lifting hairs before they are cut and providing a smooth and comfortable shaving experience. In some embodiments, a trimming blade can be placed on the back of the razor cartridge or razor handle, which, for example, may allow for a trim under a user's nose and/or upper lip.

In some embodiments, the blade cartridge comprises one or more blades. The blades are encapsulated, sandwiched (surrounded by), and secured between the top section of the cartridge and the bottom section of the cartridge possibly at, but not limited to, each linear protrusion on a top surface of the cartridge. In some embodiments, the blade does not need to be supported between each top surface protrusion.

In some embodiments, the top surface protrusions regulate the distance between the blade and the surface of the facial skin, which rubs against the linear protrusions. Variations in the blade-to-skin distances are provided by the height of the linear protrusions. In varying embodiments, three different heights of the surface protrusions are provided. In some embodiments, more surface protrusions or fewer surface protrusions may be included.

In some embodiments, a novel razor having features configured to increase the comfort of a user while the user is shaving are disclosed. In some embodiments, features and configurations thereof are disclosed which can be implemented in traditional razors that are designed to offer a “clean” shave. The disclosed features and configurations thereof may also allow a user to perform a dry shave (i.e., without needing shaving cream, oil, lubricant, soap, water, or the like to provide for a comfortable shave), which would otherwise be too uncomfortable for a user with traditional razors.

It will be appreciated that any dimensions and scaling discussed herein or depicted in the figures are exemplary, and embodiments of the disclosure are not limited thereto.

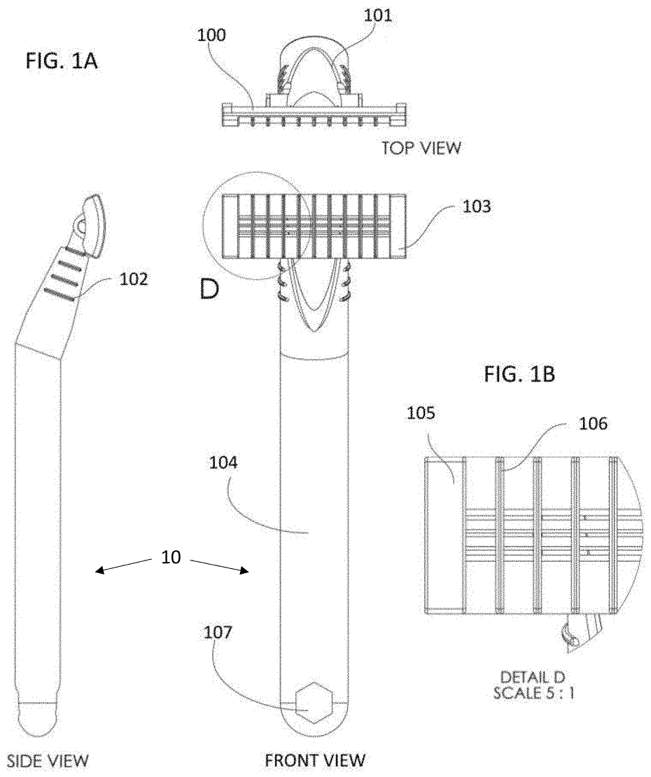

FIG. 1A depicts various views of a razor 10 according to the present disclosure. The razor 10 includes a handle 104, a pivot fork 101, and a cartridge 100. The handle 104 may be of a solid construction of various materials to achieve varying beneficial effects for a user during a shave. For example, handle 104 may be made of a light wooden or metal material for optimal rigidity while maintaining a low weight, thereby enabling a user to shave precisely with less physical effort. In some embodiments, handle 104 may be hollow or of a more flexible material in order to reduce manufacturing costs. In some embodiments, handle 104 comprises a handle opening 107 to accommodate storage of the razor 10. Although a hexagonal handle opening is depicted in FIG. 1A, it will be readily appreciated that handle opening 107 may be of varying shapes and sizes to accommodate storage of the razor 10. For example, handle opening 107 may be large enough that the razor 10 can be stored by placing a wall- or shelf-mounted hook through the handle opening 107. In some embodiments, handle opening 107 may be just large enough to accommodate one or more tethers by which the razor 10 may be tied to other razors, hung on a hook, or tied to another object. Furthermore, handle 107 does not require a hole in it, and a handle without a hole can be used.

The razor 10 also includes ribs 102 proximate to a cartridge 100. The ribs 102 may comprise a plurality of parallel protrusions that, when held by a user, increase a user's grip on the razor 10. In an embodiment, ribs 102 comprise parallel protrusions on the circumference of a pivot fork 104 and on two opposing sides of the pivot fork 104. The ribs 102 increase in length in a direction from the cartridge 100 to the handle 104 of the razor 10. Ribs 102 may be made of the same material as the handle 102 or may be of a different material to make the ribs 102 easier to distinguish by sight and feel of a user. In some embodiments, ribs 102 comprise a rubberized grip. It will be readily understood that ribs 102 may be comprised of a variety of shapes and sizes in order to enhance a user's shaving experience. Razor 10 can also be constructed without ribs 102.

Cartridge 100 includes a cutting side 103 that is applied against and dragged across a user's skin during shaving. The cutting side 103 of a cartridge is depicted in closer detail in FIG. 1B, which depicts a close-up view of a cartridge as shown in FIG. 1A. The cartridge 100 includes cartridge ends 105 on opposing ends of the cartridge 100. The cartridge ends 105 comprise the widest protrusions of the cartridge 100 on a cutting side 103 of the cartridge 100. The cartridge ends 105 also comprise the protrusions having the largest individual surface areas on the cutting side 103 of the cartridge 100, thereby ensuring optimal positioning of the cartridge and its blades on the skin of a user during a shaving process. In some embodiments, cartridge ends 105 secure the ends of one or more blades to the cartridge 100.

Cartridge 100 also includes a plurality of raised ridges 106 on the cutting side 103. The raised ridges 106 are parallel to one another. In an embodiment, raised ridges 106 are also parallel to the cartridge ends 105. In some embodiments, raised ridges 106 may extend across a narrower dimension of the cartridge 100, and perpendicular to blades in the cartridge 100. As disclosed hereinafter, the raised ridges may instead be at an angle relative to razor blades within the cartridge. Raised ridges 106 of the cartridge 100 regulate the distance of a user's hair to the blades of the cartridge 100 during shaving.

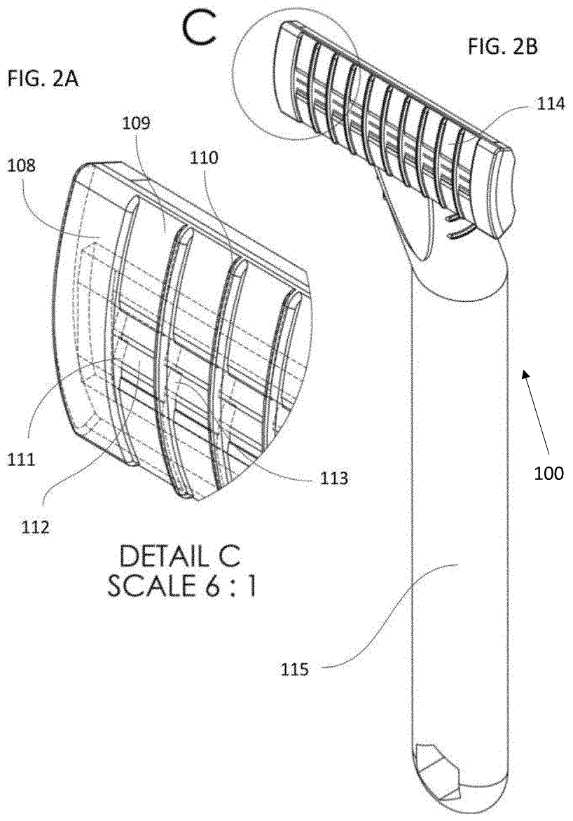

FIG. 2A depicts a close-up three-quarter view of a cartridge 100 in an embodiment of a razor according to the present disclosure.

In an embodiment, cartridge 100 includes cartridge ends 108, one or more lower surfaces 109, a plurality of raised ridges 110, and one or more blades 112. The lower surfaces 109 of the cartridge 100 do not fully contact the skin of a user because they are offset from the user's skin by the height of the raised ridges 110. In some embodiments, the position of the lower surfaces 109 represents the position at which a user's hair will be cut. For example, the lower surfaces 109 may be at a same depth, relative to the raised ridges 106 and cartridge ends 108, as the cutting edge of the blades 112 embedded within the cartridge 100. Thus, a user may feel when hair has been sufficiently cut because the sensation a user feels through the handle will be different when uncut hair rubs against the lower surfaces 109 versus when hair cut by the blade 112 contacts or does not contact the lower surfaces 109.

The cartridge ends 108 each include a cartridge end inner edge 111. Raised ridges 110 each include ridge inner edges 113. Each of the cartridge end inner edges 111 and ridge inner edges 113 are configured to form tightly around blades 112 and other parts of the cartridge 100 to eliminate gaps between components. Thus, hairs, whether cut or uncut, do not get caught between the blades 112 and cartridge components as occurs frequently with typical razors in the art. Each of the cartridge end inner edges 111 and ridge inner edges 113 may be configured in parallel to reduce scraping of hairs or hair ends against the cartridge. Furthermore, the cartridge end inner edges 111 and ridge inner edges 113 form the structure of the cartridge 100 to regulate the distance of a user's hair to the one or more blades 112.

The one or more blades 112 intersect both sides of the raised ridges 110 through their respective ridge inner edges 113, which continue to the backside of the cartridge 100. There are no gaps between the ridge inner edges 113 and the intersecting one or more blades 112. The one or more blades 112 are surrounded by the body of the cartridge in an intermittent perpendicular manner. At those positions where the cartridge 100 is raised from the exposed surface and cutting edge of the blade, each protruding surface regulates the length of the remaining portion of each hair shaft cut. When surrounding the one or more blades with a secure surface perpendicular to the blade, the intersection of the surrounding material with the blade does not allow hair shafts to wedge or go between the surrounding material and the blade. A no gap condition is formed between the blade and external cartridge housing. The two materials are mated which forms a complete cartridge where no material can get between the exterior cartridge housing material and the internally configured one or more blades 112.

In some embodiments, the cartridge ends 108 and raised ridges 110 comprise rounded edges to ensure minimal scraping, scratching, or catching of the cartridge against a user's skin. Furthermore, rounded edges facilitate gradual pressing or contact of the cartridge against the user's skin.

The one or more blades 112 in the cartridge are supported by the cartridge ends 108 on either side of the cartridge such that blades 112 are angled, with the cutting edge of the blades 112 angled towards the cutting side of the cartridge 100.

FIG. 2B depicts a three-quarter view of the razor 100 of FIG. 2A. The razor 100 includes a handle 115 and a cartridge having lower surfaces 114 offset from the cutting side of the cartridge ends 108 and raised ridges 110. The lower surfaces 114 have the same depth relative to the raised ridges 110 on both a leading edge and trailing edge of the cartridge, flanking the one or more blades 112 in the cartridge 100.

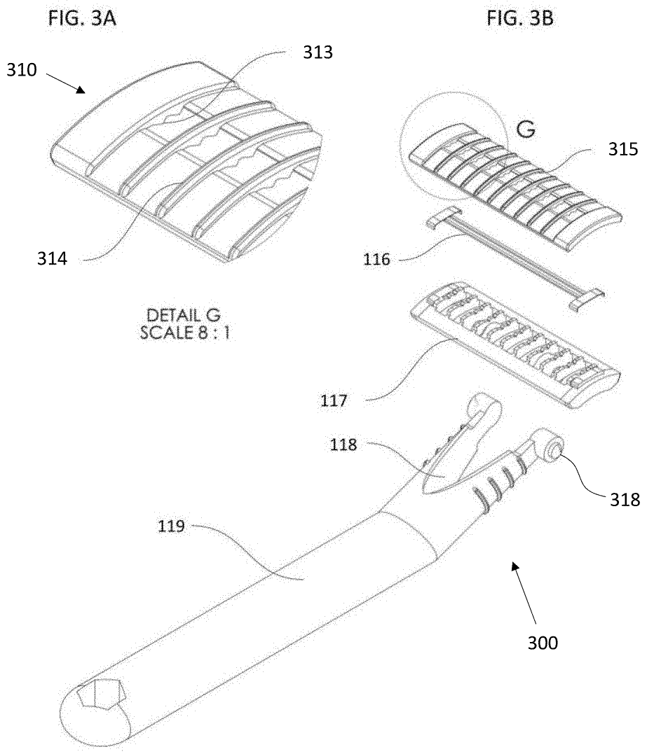

FIG. 3A depicts a close-up view of a cartridge 206 in an embodiment of the present disclosure.

Lower surface 313 is configured between each of the raised ridges 314. In some embodiments, lower surface 313 is configured to be the same depth as the cutting blades. Lower surface 313 continues intermittently throughout the blade length and is configured on both the leading edge and trailing edge of the cartridge, flanking one or more blades in the cartridge.

Raised ridges 314 are configured to regulate the distance of a user's hair to the one or more blades during a shaving process. In some embodiments, the one or more blades intersect the base of the raised ridges 314 and front facing raised ridges only appear on a cartridge top component 315.

FIG. 3B depicts an exploded view of a razor 300 according to the present disclosure.

In some embodiments, a cartridge assembly 310 includes a cartridge top component 315 and a cartridge lower component 117. In an assembled state, the cartridge assembly 310 includes a blade carriage 116 secured between the cartridge top component 315 and the cartridge bottom component 117. When the cartridge top component 315 is joined with cartridge bottom component 117, there are no visible seams between the blade carriage 116 and the cartridge assembly 310. Furthermore, in an assembled state, there are no visible gaps between the cartridge top component 315, one or more blades secured in the blade carriage 116, and the cartridge bottom component 117. In some embodiments, the blade carriage 116 is configured to secure one or more single blades in the cartridge assembly 310. In some embodiments, the blade carriage 116 is configured to secure a double blade or a double edge blade.

In some embodiments, razor 300 includes a handle 115 and a mounting fork 118. The mounting fork 118 may be a squeezable fork at an end of the handle 115 upon which the cartridge assembly 310 is mounted. In some embodiments, the mounting fork 118 includes pivot protrusions 318 upon which the cartridge assembly 310 can be mounted. For example, the mounting fork 118 may exert a force outward from the fork in the direction of the pivot protrusions 318 into the cartridge bottom component 117, thereby securing the cartridge assembly 310 to the mounting fork 118. A user may squeeze the mounting fork 118 to counteract the outward force exerted by the mounting fork 118 and thereby release a cartridge assembly 310 so that a replacement can be mounted in its place.

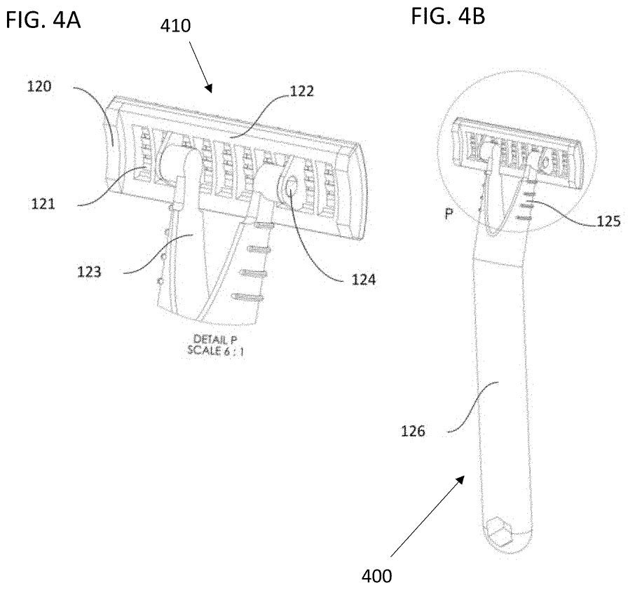

FIG. 4A depicts a close-up rear view of a razor 400 according to the present disclosure.

In some embodiments, a razor 400 includes a cartridge assembly 410 having a rear side 120. In some embodiments, the rear side 120 has a raised ridge on each end of the length of the cartridge assembly to increase the rigidity and strength of the cartridge assembly 410. In addition, the raised ridges of the rear side 120 provide additional structural support to secure the one or more blades in the cartridge assembly 410 via a blade carriage.

In some embodiments, cartridge assembly 410 includes rear openings 121 along the rear side 120, which allow for the passage of trimmed hair, shaving products such as shaving cream, and liquids through the cartridge assembly 410.

In some embodiments, the cartridge assembly 410 includes a rear side trailing edge 122. A solid rail extending along the length of the trailing edge is included for structural rigidity of the cartridge assembly 410. The solid rail extends at least along the length of the cartridge assembly through which one or more blades are exposed. In some embodiments, a solid rail is also included on the rear side leading edge of the cartridge assembly.

As shown in FIG. 4A, a mounting fork of the razor 400 may include an inner surface 123. The inner surface is symmetrical over the plane extending through an axis of the mounting fork and the shortest width of the cartridge assembly 410. Also shown in FIG. 4A are pivot protrusions 124, which are pivotally mated with pivot openings on the rear side of the cartridge assembly.

FIG. 4B depicts a rear three-quarter view of an embodiment of the razor 400 of the present disclosure.

In some embodiments, razor 400 includes a handle 126 through which a user applies pressure through the cartridge assembly to the user's skin. In some embodiments, grip lines 125 include raised protrusions that enable a user to grip and squeeze the mounting fork of the razor 400.

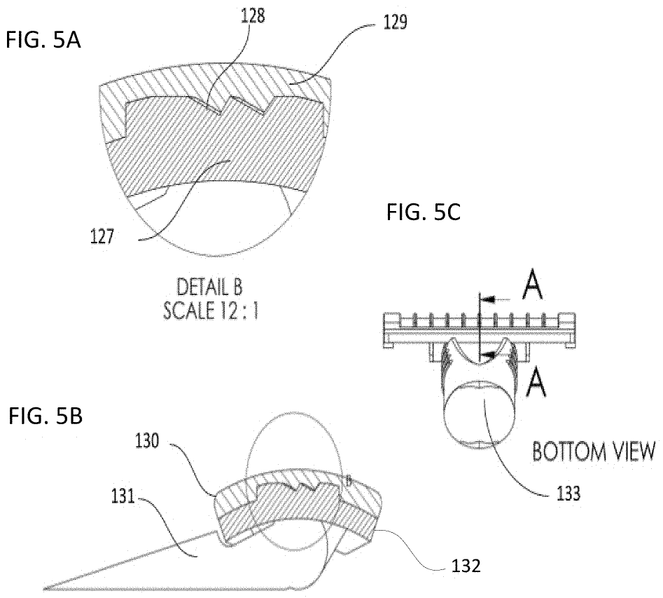

FIG. 5A depicts a close-up cross-sectional view of a cartridge of an embodiment of a razor according to the present disclosure.

In some embodiments, a cartridge cross section includes a cartridge bottom component 127, one or more blades 128, and a cartridge top component 129.

FIG. 5B depicts a close-up cross-sectional view of a detachable razor cartridge of an embodiment of a razor according to the present disclosure.

As shown in FIG. 5B, the cartridge top component 129 has a cross section 130 that extends across the full width of the cartridge assembly. In some embodiments, the cartridge top component 129 includes raised ridges that may be of varying height depending on a desired length of a user's hair. For example, the height of the ridges can be configured to cut a user's hair at a distance of 0.4 mm, 1 mm, or 1.5 mm from the user's skin. Embodiments of the present disclosure are not limited to 0.4 mm, 1 mm, or 1.5 mm, but may include lengths from 0.01 mm to 10 mm. Thus, non-adjustable cartridges can be made to accommodate the various choices preferred by consumers.

Also shown in FIG. 5B is a mounting fork cross section 131. In some embodiments, the mounting fork includes a recess to accommodate the cartridge assembly when the cartridge is pivoted towards the mounting fork. Thus, the cartridge assembly may have a greater range of pivotal motion and nest in the recess of the mounting fork.

As can be seen in FIG. 5B, the cartridge bottom component 127 has a cross-section 132 that extends along a full width of the cartridge assembly.

FIG. 5C depicts a bottom view of an embodiment of a razor assembly according to the present disclosure. Specifically, FIG. 5C depicts a handle end 133 and a cross-section plane A through which FIGS. 5A and 5B may be viewed.

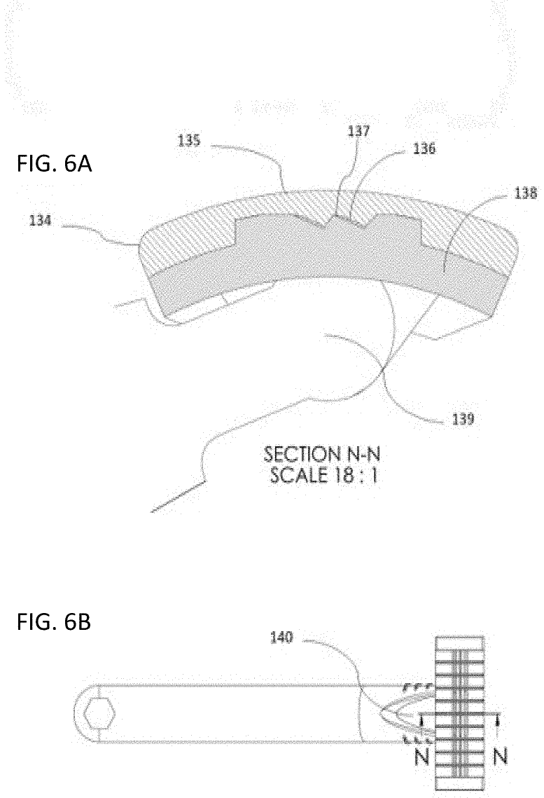

FIG. 6A depicts a close-up cross-sectional view of a cartridge assembly of a razor according to the present disclosure.

As shown in FIG. 6A, the cross-section 138 of the cartridge assembly includes rounded edges 134 on the leading edge and the trailing edge of raised ridges which regulate the length of the stubble or trimmed hair, thereby preventing scraping when a user shaves and increasing a user's comfort while shaving. In some embodiments, a curved cartridge top component 135 is also included to increase user comfort and shaving precision.

In some embodiments, the cartridge assembly has a cross section of one or more blades 136 sandwiched between a cartridge top component and cartridge bottom component. As depicted in FIG. 6A, the one or more blades are angled for a beveled blade leading surface with sharp edge 137, which is parallel with the closest portion of the curved cartridge top component 135.

In some embodiments, the cartridge assembly is molded such that the cartridge top component and the one or more blades are combined in a single shot injection mold around the one or more blades 136. Thus, the one or more blades 136 may be embedded in cartridge assembly components to ensure no gaps between the cartridge and assembly and the one or more blades do not snag a user's hair during a shaving process.

As shown in FIG. 6A, a razor may include a cross section of cartridge bottom component with integral handle pivot points and a handle pivot point connector 139.

In an embodiment of a manufacturing method to create a condition of securing the cutting blade where there is no gap between the blade and the housing with raised protruding surfaces, the blade can be sandwiched between top and bottom plastic pieces. To create a condition of securing the cutting blade where there is no gap between the blade and the housing with raised protruding surfaces, the blade can be placed in the tool as a tool insert then plastic is injected around the blade in the injection molding process, leaving areas along the blade length where the blade is exposed with no plastic on the blade surface. To create a condition of no gap between the blade cutting surfaces and the intermittent protrusions the cartridge can be cast in metal as a single piece. In the areas between the protruding surface that regulates the length of cutting of each hair shaft the metal surfaces can be sharpened to a cutting edge thus creating the complete cartridge out of one solid cast piece.

FIG. 6B depicts a plan view of an embodiment of a razor showing the cross-sectional plane N 140 of FIG. 6A.

In some embodiments, the cartridge assembly is molded such that the cartridge top component, the cartridge bottom component, and the one or more blades are combined in a single shot injection mold around the one or more blades 136. Thus, a single unitary cartridge may be modeled with one or more blades 136 embedded.

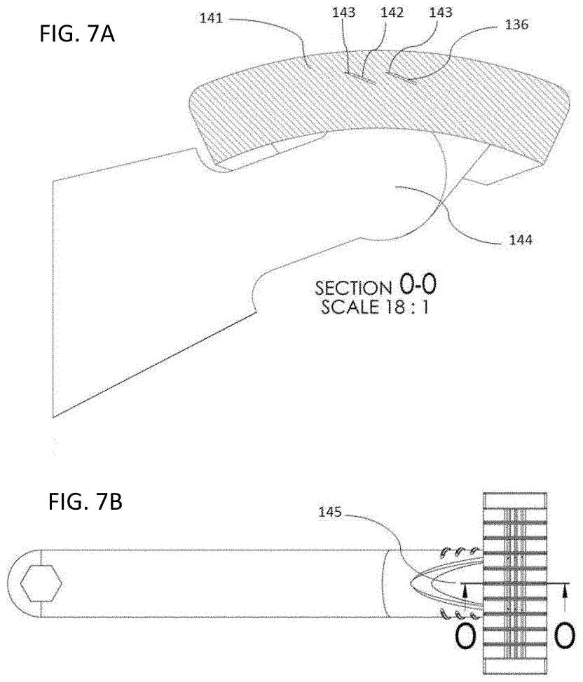

FIG. 7A depicts a close-up cross sectional view of razor blades in a cartridge of an embodiment of a razor according to the present disclosure.

A single injection molded plastic part 141 is illustrated in FIG. 7A section 0-0 with one or more blades 142 suspended in the middle of the single injection molded plastic part 141. The distance between beveled surface 143 and the top curved surface of the raised area of the single injection molded plastic part 141 determines the length of hair cut or stubble to remain after a shave.

The one or more blades 142 include a beveled surface 143. In some embodiments, the beveled surface 143 is configured to be parallel to the top of the single injection molded plastic part 141.

As shown in FIG. 7A, a single injection molded plastic part 141 may also be configured to pivotally connect with the handle via handle pivot point 144.

FIG. 7B depicts a plan view of an embodiment of a razor having the cross-sectional plane O 145 of FIG. 7A.

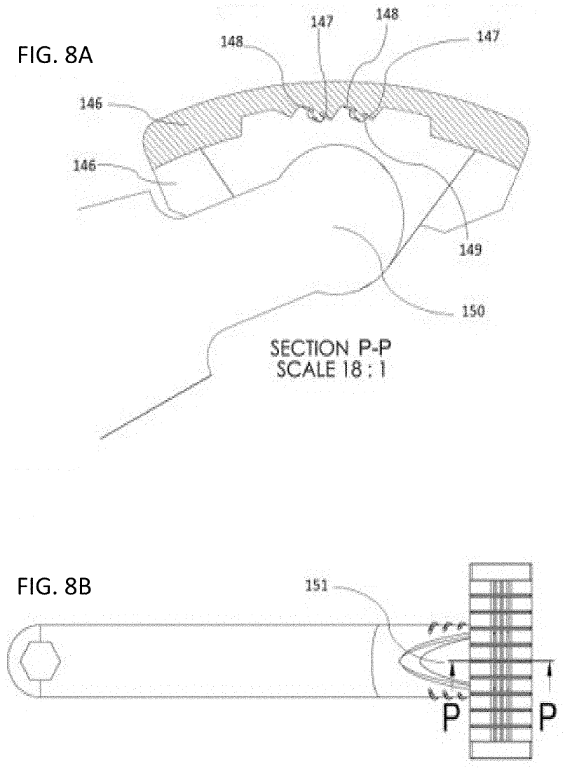

FIG. 8A depicts a close-up cross sectional view of razor blades in a cartridge of an embodiment of a razor according to the present disclosure.

As shown in FIG. 8A, in some embodiments, a molding method provides a single plastic injection molded plastic frame 146. At each intersection of one or more blades to the plastic frame 146, one or more protruding plastic pegs 149 may be included which extend through the one or more blades 147 to secure the one or more blades 147 to the frame 146. In some embodiments, the one or more pegs 149 are inserted into the one or more blades 147 in a non-deformed state during an assembly process. Then, to more permanently secure the one or more blades 147 to the frame 146, a portion of each of the one or more pegs 149 extending beyond the one or more blades 147 may be deformed. For example, the one or more pegs 149 may serve as heat stakes to secure the one or more blades 147 to the frame 146. In some embodiments, the one or more pegs 149 may be deformed to secure the one or more blades 147 to the frame 146 by other mechanical means. This configuration captures the one or more blades 147 on the underside of the cartridge. Each of the one or more blades 147 is angled or pitched with the sharp machined chamfered edge 148 tilted upwards towards the side of the cartridge facing a user's skin during a shaving process. The blade chamfered edge 148 is parallel to the top edge of each lower surface and/or raised ridge. The distance of the sharpened blade chamfered edge 148 to the top surface of the cartridge regulates the length of the cut hair. In some embodiments a handle pivot point connector 150 is also included.

In embodiments having at least two blades 147, one of the at least two blades 147 may be configured at a different pitch angle than the remaining blades 147. For example, one of the blades 147 may be configured as a leading blade angled to lift hair into an optimal position for the remaining blades 147 to cut the hair. In some embodiments, the leading blade may have different properties from the remaining blades 147. For example, the leading blade may have a different sharpness than the remaining blades to enable the leading blade to more comfortably position hair for the remaining sharper blades 147 to cut the hair. It will be readily understood that a leading blade is the blade which, when the razor is in use, is positioned first in a direction of shaving, and is therefore configured to contact a user's hair before the remaining blades 147.

FIG. 8B depicts a plan view of an embodiment of a razor having the cross-sectional plane P 151 of FIG. 8A.

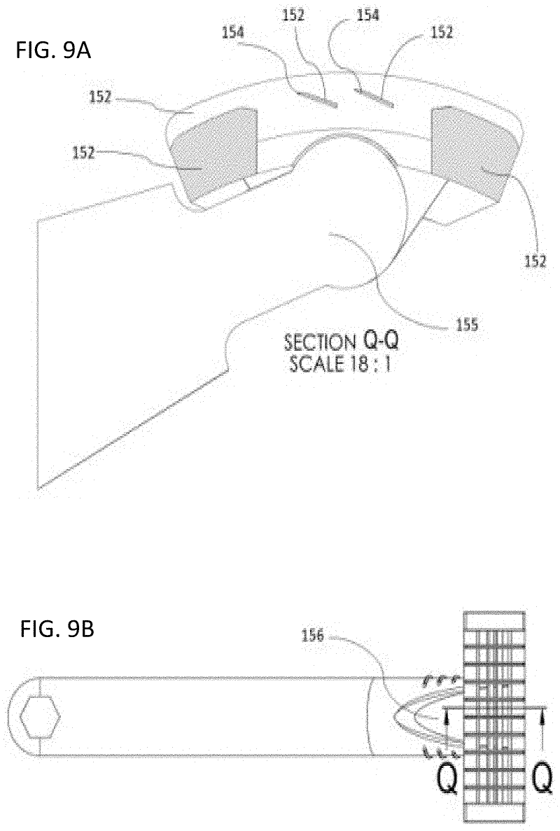

FIG. 9A depicts a close-up cross-sectional view of razor blades in a cartridge of an embodiment of a razor according to the present disclosure.

As shown in FIG. 9A, in some embodiments, to create a condition of no gap between the blade cutting surfaces and the intermittent protrusions, the cartridge can be cast in metal as a single piece 152. In the areas between the protruding surface that regulates the length of cutting of each hair shaft, the metal surfaces can be sharpened to a chamfer and such that cutting edge 154 is parallel to the top surface of the cartridge. The distance between the cutting edge and top surface of intermittent protrusions determines the length of hair cut or hair stubble to remain after the shave. In some embodiments a handle pivot point connector 155 is also included.

FIG. 9B depicts a plan view of an embodiment of a razor having the cross-sectional plane Q 156 of FIG. 9A.

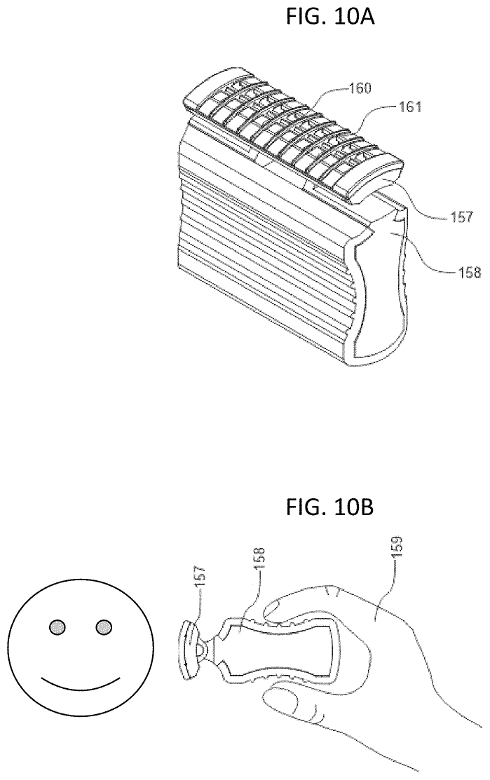

FIG. 10A depicts an embodiment of a razor having a wide handle and detachable blade according to the present disclosure.

In an embodiment, a detachable razor blade cartridge 157 is detachably connected to a wide handle 158. The wide handle 158 aids in enabling a user to shave in both the upward and downward directions (i.e., against and with the grain of a user's hair). The length, or amount of exposed blade, of at least one razor blade 160 is set at predetermined intervals. That is, the length or amount of the at least one razor blade 160 that is exposed to the user is set at predetermined intervals. At each interval, a rib 161 extends over the at least one razor blade 160 and acts as a guard.

FIG. 10B depicts a gripping or handling configuration of the wide handle depicted in FIG. 10A.

Wide handle 158 can be grasped by a user's hand 159 and offers the ability to comfortably shave in both the up and down directions (with and against a grain of the user's hair). Cartridge 157 is connected to wide handle 158 in a manner which allows a shaver to move his or her hand 159 up and down, parallel or close to parallel to the surface of the user's skin, thus allowing for blade(s) 160 to cut hair when moved both in an upwards and downward motion. The wide handle 158 allows for easier and more accurate location for hair trimming due to the hand 159 being closer to the razor blade cartridge 157.

Wide handle 158 is also more ergonomically friendly than traditional razor blade handles, which are more stick-like (i.e., a much greater length to width ratio) and are used in combination with a razor blade cartridge that is less versatile than the disclosed cartridge assembly. For example, traditional razor blade handles may be configured only for single-direction shaving motions or even for only a single shaving angle if an attached razor blade cartridge is not configured to pivot for a more comfortable and accommodating shave. In contrast, wide handle 158 has an increased surface area for contact with a user's finger tips, allowing a user to more comfortably grip the handle in a variety of positions and have greater control of the razor's movement during a shave. Wide handle 158 would allow for the thumb to be placed on one side with one or more other fingers placed on the side opposite. Although wide handle 158 could be made in various sizes, in some embodiments the dimensions of the wide handle 158 are 3-4 inches in length, 1.5-2 inches in thickness and 3 inches in width. Depending on the razor cartridge used, the wide handle 158 works the same regardless of which side the thumb was placed on. However, there could also be grooves or spaces for placement of the thumb and fingers, which may then require one side for the thumb and the other for the fingers.

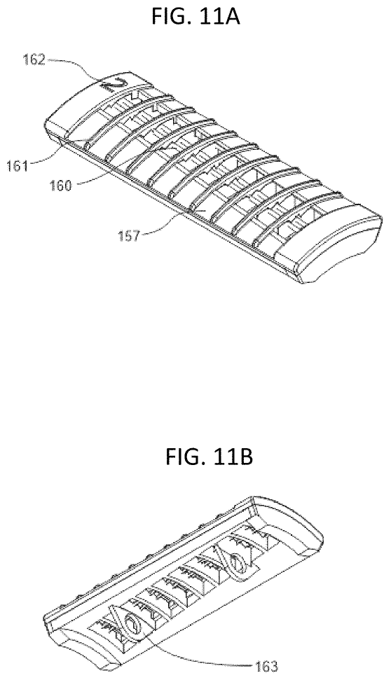

FIG. 11A depicts razor blades disposed at an angle across an embodiment of a razor according to the present disclosure.

In an embodiment, a detachable razor blade cartridge 157 includes at least one razor blade 160 which lies at an angle, across the detachable razor blade cartridge 157, extending from a first corner area of a first end of the detachable razor blade cartridge 157 to a second corner area of a second end of the detachable razor blade cartridge 157. Depending upon the angle, the at least one razor blade 160 may be located in an exact corner of the first end if the detachable razor blade cartridge 157, or the middle of the first end of the detachable razor blade cartridge 157, or at a position in between the exact corner and the middle. Depending upon the number of razor blades included in the detachable razor blade cartridge 157, each razor blade may extend across part or all of the detachable razor blade cartridge 157, and each blade may extend across the detachable razor blade cartridge 157 at a different angle than another blade or may extend at the same angle but be located at a different position on the detachable razor blade cartridge 157. This means, for example, that a first end of a first blade may extend across the detachable razor blade cartridge 157 from a first exact corner on the first end of the detachable razor blade cartridge 157 at a 50 degree angle to the middle point of the second end of the detachable razor blade cartridge 157. A second blade may extend across the detachable razor blade cartridge 157 in a similar manner but, instead, a first end of the second blade may extend across the detachable razor blade cartridge 157 from a point between the first exact corner and the middle of the first end of the detachable razor blade cartridge 157 at a 50 degree angle, and the second end of the blade may terminate at a first exact corner of the second end of the detachable razor blade cartridge 157. A benefit of embodiments having one or more angled blades is that they cause less pulling and tugging of hair while shaving, and a smoother, more comfortable shaving experience may be provided.

Additionally, the length, or amount of exposed blade, of the at least one razor blade 160 exposed to the user is set at predetermined intervals. At each interval, a rib 161 extends over the at least one razor blade 160 and acts as a guard. A symbol 162 is included on the detachable razor blade cartridge 157 and may be a number, letter, picture, or other symbol marking, and indicates the resulting length of hair that will remain after the user shaves that, or those, hair or hairs. For example, indicia such as “1” may indicate the razor cartridge will leave 0.5 mm of hair remaining or a 5 o'clock shadow. If the number “2” was labeled on the cartridge, that may indicate 1 mm of hair will remain after the shave or a stubble-look. If the number “3” was labeled on the cartridge, that may indicate 1.5 mm of hair would remain after the shave or a scruff-look. Note that these length values and indicia are examples only. Other lengths and indicia could be used.

FIG. 11B depicts an underside of a detachable cartridge according to FIG. 11A.

The detachable razor blade cartridge 157 of the embodiment shown in FIG. 11A discussed above includes at least one detachable connection point 163, which detachably connects the detachable razor blade cartridge 157 to a razor handle.

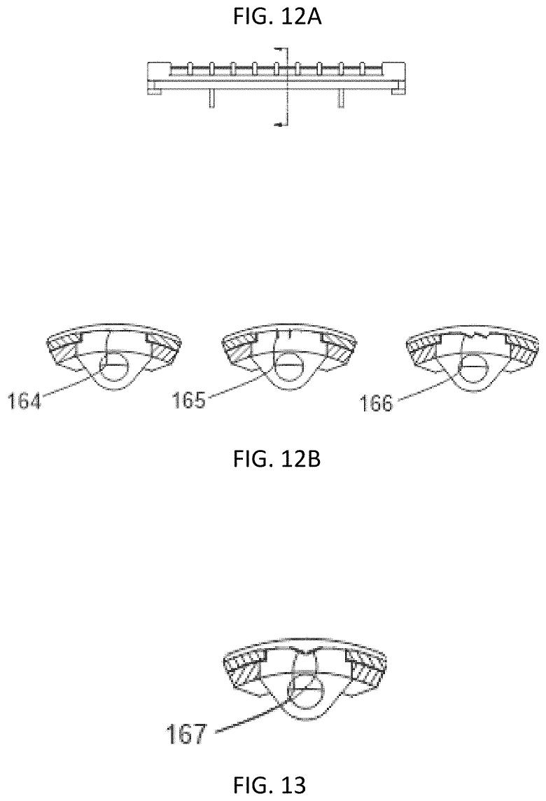

FIG. 12A depicts a front view of a detachable cartridge of an embodiment of a razor according to the present disclosure.

As shown in FIG. 12A, in some embodiments, a detachable razor blade cartridge includes at least one razor blade, wherein the at least one razor blade is included in the detachable razor blade cartridge at a pre-set angle. The pre-set angle may be a pitch angle of the razor blade, and be an angle between 0 degrees and 180 degrees, and preferably an angle of or between 30 degrees to 90 degrees (or 120 degrees to 180 degrees, depending upon orientation). At 90 degrees, the sharp edge of the razor blade is perpendicular to the guard-ribs. At 0 degrees or 180 degrees the top of the blade (the non-sharp part) is parallel with the guard-ribs.

FIG. 12B depicts side views of different embodiments of a razor according to the present disclosure having varying blade angle configurations.

In embodiments according to FIG. 12A having at least one razor blade having a pitch angle, the at least one razor blade may be configured as shown in FIG. 12B. FIG. 12B shows three exemplary pitch angles only, but it will be readily understood that additional pitch angles are possible without deviating from the spirit of the invention. In the left figure, the at least one razor blade 164 is disposed at a near 0 degree angle from horizontal, almost parallel to the razor blade guard, but may be an angle greater than 0 degrees and less than 90 degrees. In the middle figure, the at least one razor blade 165 is vertical, at 90 degrees. In the right figure, the at least one razor blade 166 is at an angle greater than 90 degrees and less than 180 degrees. The pitch angle of the blade is fixed. However, the razor blade cartridges are detachable from the razor blade handle. For example, a user could use cartridge 164 for one shave and 165 for another depending on the desired outcome.

FIG. 13 depicts a side view of a detachable cartridge with differently-oriented razor blades in an embodiment of a razor according to the present disclosure.

In some embodiments, detachable razor blade cartridge 167 includes a plurality of razor blades pitched at opposite angles to allow for shaving in both directions (upward and downward). An embodiment of detachable razor blade cartridge 167 could have 1, 2 or 3 razor blades set a certain angle pitch such as 30-45 degrees with another 1, 2 or 3 razor blades set at 120-135 degrees, allowing for a user to shave in an upward motion, with only the 1, 2, or 3 blades set at 30-45 degrees cutting hair but then allowing for the other 1, 2 or 3 blades set at a 120-135 degree angle pitch to trim hair when the user shaves in a downward motion. Some of the 2-6 blades would be used for shaving in one direction with the remaining to be used when shaving in the opposite direction. This allows for hair trimming on both an upward and downward motion and for certain blade(s) to be set aside either for a trim during the upward shave and the other blade(s) for the downward shave. Cartridge 167 shows two blades, with one at a pre-set angle pitch that cuts hair when the razor cartridge is brought down against the facial hair and then the other blade being used to trim the facial hair when the cartridge is being used in an upward motion on the face. Thus, a much more efficient and timelier shave may be achieved, as every shave stroke, regardless if up or down, is removing hair.

It should be noted that, unless indicated otherwise, each of the above described embodiments may be combinable and that features of one described embodiment may be included or combined with features of other described embodiments in exemplary embodiments of the present invention. Additionally, while certain exemplary embodiments are described or depicted herein as detachable razor blade cartridges, it should be understood that these razor cartridges may be permanently and fixedly, and not detachably, connected to a razor blade handle.

While exemplary embodiments of the invention have been illustrated and described in detail in the drawings and foregoing description, such illustrations and descriptions are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

All references, including publications, patent applications, and patents, cited herein are hereby incorporated by reference to the same extent as if each reference were individually and specifically indicated to be incorporated by reference and were set forth in its entirety herein.

1. A razor assembly comprising a cartridge assembly for housing one or more blades, wherein:
the cartridge assembly comprises a plurality of raised ridges configured to slide against the surface of a user's skin and offset a distance relative to the surface of the user's skin at which the one or more blades cut hair, and
the one or more blades are incorporated into the cartridge assembly without gaps between each of the one or more blades and the cartridge assembly.

2. The razor assembly of claim 1, wherein the cartridge assembly is a single unit having the one or more blades embedded within.

3. The razor assembly of claim 1, wherein the cartridge assembly comprises a cartridge top component and a cartridge bottom component and the one or more blades are sandwiched between the cartridge top component and the cartridge bottom component.

4. The razor assembly of claim 3, wherein at least one of the cartridge top component and the cartridge bottom component comprise a single injection mold with the one or more blades embedded within.

5. The razor assembly of claim 3, wherein the cartridge assembly further comprises a blade carriage configured to house the one or more blades and secure the one or more blades within the cartridge assembly, the blade carriage being sandwiched between the cartridge top component and the cartridge bottom component.

6. The razor assembly of claim 1, wherein the cartridge assembly comprises a curved outer edge configured to contact a user's skin, and wherein the one or more blades comprise cutting edges that are parallel to a plane tangent to the curved outer edge.

7. The razor assembly of claim 1, wherein the one or more blades are angled relative to an axis of the cartridge assembly extending along a length of the cartridge assembly.

8. The razor assembly of claim 7, wherein the one or more blades extend along different portions along the largest dimension of the cartridge assembly.

9. The razor assembly of claim 1 comprising at least two blades, and wherein the at least two blades are configured at different angles relative to an outer surface of the cartridge assembly.

10. The razor assembly of claim 1 further comprising a handle having a mounting fork.

11. The razor assembly of claim 1, wherein the mounting fork comprises pivot protrusions and the cartridge assembly comprises pivot recesses, the pivot protrusions configured to mate with the pivot recesses in an assembled state.

12. The razor assembly of claim 11, wherein the mounting fork is configured to be compressible such that at least one of the pivot protrusions is released from a pivot recess.

13. The razor assembly of claim 12, wherein the mounting fork comprises grip lines protruding outward from the mounting fork.

14. The razor assembly of claim 1, wherein the distance is 0.4 to 4 millimeters.

15. The razor assembly of claim 10, wherein the mounting fork comprises a recess configured to accommodate pivotal rotation of the cartridge assembly into the mounting fork.

16. The razor assembly of claim 1, wherein the cartridge assembly further comprises one or more pegs, each of the one or more pegs configured to extend through the one or more blades and secure the one or more blades in the cartridge assembly when the one or more pegs are deformed.

17. A method of making a razor cartridge assembly, comprising:
providing a mold cavity;
securing one or more razor blades within the mold cavity; and
injection molding the cartridge assembly about the one or more razor blades.

18. The method of claim 17, further comprising angling the one or more razor blades such that at least two of the razor blades are not parallel.

19. The method of claim 17, further comprising angling the one or more razor blades such that the one or more razor blades are not parallel to an axis extending across the length of the mold.

20. The method of claim 17, further comprising sharpening a cutting edge of the one or more blades such that each cutting edge is parallel to a plane tangent to an outer surface of the cartridge assembly.
